(19) United States
(12) Patent Application Publication
(10) Pub. No.: US 2022/0306001 A1
(43) Pub. Date: Sep. 29, 2022

(54) IN-CABIN MONITORING SYSTEM

(71) Applicant: Panasonic Intellectual Property Management Co., Ltd., Osaka (JP)

(72) Inventors: Yoshiteru MINO, Osaka (JP); Hideki TAKAHASHI, Osaka (JP); Tatsuki HOTANI, Kanagawa (JP); Shinji TAKENAKA, Kanagawa (JP)

(73) Assignee: Panasonic Intellectual Property Management Co., Ltd., Osaka (JP)

(21) Appl. No.: 17/699,995

(22) Filed: Mar. 21, 2022

(30) Foreign Application Priority Data
Mar. 29, 2021 (JP) 2021-056317

(51) Int. Cl. B60R 1/29; G02B 7/182; B60R 1/12; B60Q 3/258; B60Q 3/80; H04N 5/225; H04N 5/235

(52) U.S. Cl. CPC B60R 1/29; G02B 7/182; B60R 1/1207; B60Q 3/258; B60Q 3/80; H04N 5/2256; H04N 5/2257; H04N 5/2351; H04N 5/2354; B60R 2001/1253

(57) ABSTRACT

An in-cabin monitoring system includes an electronic mirror provided inside a vehicle cabin, a camera that captures an image of an imaging target inside the vehicle cabin, and a light source that is provided in the electronic mirror and emits light into the vehicle cabin. The light source includes a plurality of light emitting diodes, and at least one light emitting diode of the plurality of light emitting diodes are disposed such that optical axes of the one or more light emitting diodes extend in directions different from a direction of an optical axis of an other light emitting diode of the plurality of light emitting diodes.

### CROSS REFERENCE TO RELATED APPLICATION

The present application is based on and claims priority of Japanese Patent Application No. 2021-056317 filed on Mar. 29, 2021.

### FIELD

The present disclosure relates to an in-cabin monitoring system that monitors, for example, an occupant inside a vehicle cabin.

### BACKGROUND

There is conventionally known an in-cabin monitoring system that monitors, for example, an occupant inside a vehicle cabin. As one example of such in-cabin monitoring systems, Patent Literature (PTL) 1 discloses a technique for controlling the quantity of light inside a vehicle cabin so as to facilitate detection of an occupant inside the vehicle cabin by use of a camera.

### CITATION LIST

### Patent Literature

PTL 1: Japanese Unexamined Patent Application Publication No. 2019-123421

### SUMMARY

However, the in-cabin monitoring system according to PTL 1 can be improved upon. In view of this, the present disclosure provides an in-cabin monitoring system capable of improving upon the above related art.

To address the above, an in-cabin monitoring system according to one aspect of the present disclosure includes: an electronic mirror provided inside a vehicle cabin; a camera that captures an image of an imaging target inside the vehicle cabin; and a light source that is provided in the electronic mirror and emits light into the vehicle cabin, wherein the light source includes a plurality of light emitting diodes, and at least one light emitting diode of the plurality of light emitting diodes is disposed such that an optical axis of the at least one light emitting diode extends in a direction different from a direction of an optical axis of an other light emitting diode of the plurality of light emitting diodes.

It is to be noted that general or specific aspects of the above may be implemented in the form of a system, a method, an integrated circuit, a computer program, or a computer readable recording medium, such as a CD-ROM, or through any desired combination of a system, a method, an integrated circuit, a computer program, and a recording medium.

An in-cabin monitoring system according to one aspect of the present disclosure is capable of improving upon the above related art.

### BRIEF DESCRIPTION OF THE DRAWINGS

These and other advantages and features of the present disclosure will become apparent from the following description thereof taken in conjunction with the accompanying drawings that illustrate a specific embodiment of the present disclosure.

FIGS. 1(a) and 1(b) are diagrams schematically illustrating an in-cabin monitoring system according to a comparative example, as viewed from the above.

FIG. 2 is a schematic diagram of an in-cabin monitoring system according to one embodiment, as viewed in the forward direction from the rear end of the vehicle cabin.

FIG. 3 is a block configuration diagram illustrating an in-cabin monitoring system according to one embodiment.

FIG. 4 is a diagram illustrating an in-cabin monitoring system according to one embodiment, as viewed toward the front side of an electronic mirror.

FIG. 5 is a sectional view of an in-cabin monitoring system according to one embodiment, as viewed along the V-V line indicated in FIG. 4.

FIG. 6(a) is a diagram schematically illustrating an in-cabin monitoring system according to one embodiment, as viewed from the above; FIG. 6(b) is an enlarged sectional view of a first light source, as viewed from the above; and FIG. 6(c) is an enlarged sectional view of a second light source, as viewed from the above.

FIG. 7(a) is a diagram illustrating a state in which an electronic mirror of an in-cabin monitoring system is disposed in a tilted orientation, and FIG. 7(b) is an enlarged sectional view of a first light source, as viewed from the above.

FIGS. 8(a) and 8(b) are diagrams illustrating some examples of a plurality of regions of an imaging target whose image is to be captured by an in-cabin monitoring system.

FIG. 9(a) is a diagram schematically illustrating light sources of an in-cabin monitoring system according to Variation 1 of one embodiment, as viewed from the above; and FIG. 9(b) is an enlarged sectional view of a first light source, as viewed from the above.

FIG. 10(a) is a diagram schematically illustrating an in-cabin monitoring system according to Variation 2 of one embodiment, as viewed from the above; and FIG. 10(b) is an enlarged sectional view of a second light source, as viewed from the above.

FIG. 11(a) is a diagram illustrating a state in which an electronic mirror of an in-cabin monitoring system according to Variation 2 of one embodiment is disposed in a tilted orientation, and

FIG. 11(b) is an enlarged sectional view of a second light source, as viewed from the above.

FIG. 12 is a sectional view of an electronic mirror of an in-cabin monitoring system according to Variation 3 of one embodiment, as viewed from the side.

### DESCRIPTION OF EMBODIMENTS

An in-cabin monitoring system is an imaging system that monitors an occupant inside a vehicle cabin and the environment inside the vehicle cabin. The in-cabin monitoring system captures an image of an imaging target by use of a camera and a light source and displays a captured image on an electronic mirror. The imaging target is, for example, an occupant inside the vehicle cabin or an object, such as a seat, inside the vehicle cabin.

For example, PTL 1 discloses a technique for controlling the quantity of light inside the vehicle cabin so as to facilitate detection of an occupant inside the vehicle cabin by use of a camera. However, even when the quantity of light inside the vehicle cabin is controlled, depending on the orientation of the light source that emits light, it may not be possible to appropriately irradiate, for example, an occupant with the light. When the imaging target, such as the occupant, cannot be irradiated appropriately with light, this makes it difficult to obtain an image of the imaging target with high accuracy.

Moreover, when the camera and the light source are disposed in the vicinity of the casing of the electronic mirror in the in-cabin monitoring system, for example, the camera and so on become visible to the occupant, and this may cause the occupant to feel psychological pressure. In addressing this point, it is conceivable to dispose the camera and the light source inside the casing of the electronic mirror. Disposing the camera and the light source inside the casing of the electronic mirror, however, can lead to some issues such as those described below.

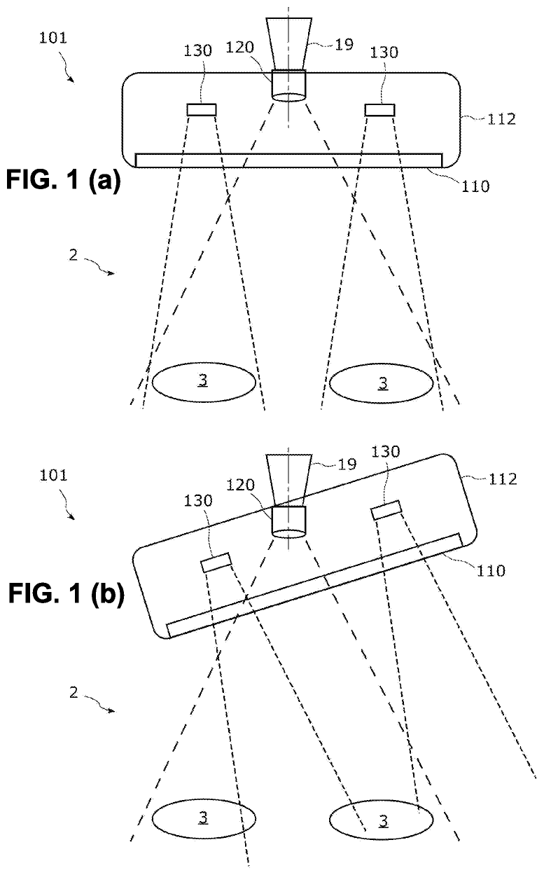

FIG. 1 is a diagram schematically illustrating in-cabin monitoring system 101 according to a comparative example, as viewed from the above.

In-cabin monitoring system 101 according to the comparative example includes electronic mirror 110, camera 120, and a plurality of light sources 130. As illustrated in FIG. 1, camera 120 is fixed to support member 19 provided inside vehicle cabin 2, and electronic mirror 110 is rotatably connected to support member 19. The plurality of light sources 130 are provided inside casing 112 of electronic mirror 110.

According to this comparative example, when electronic mirror 110 is oriented directly toward the rear end of vehicle cabin 2 as illustrated in (a) in FIG. 1, each light source 130 can appropriately irradiate corresponding imaging target 3 with light. In contrast, when electronic mirror 110 is disposed in a tilted orientation instead of being oriented directly toward the rear end of vehicle cabin 2 as illustrated in (b) in FIG. 1, light sources 130 cannot appropriately irradiate their corresponding imaging targets 3 with light. When imaging target 3 cannot be irradiated appropriately with light, this creates an issue that an image of imaging target 3 cannot be obtained with high accuracy.

In this respect, an in-cabin monitoring system according to the present disclosure has a configuration described hereinafter so that the in-cabin monitoring system can appropriately irradiate imaging target 3 inside vehicle cabin 2 with light.

An in-cabin monitoring system according to one aspect of the present disclosure includes an electronic mirror provided inside a vehicle cabin, a camera that captures an image of an imaging target inside the vehicle cabin, and a light source that is provided in the electronic mirror and emits light into the vehicle cabin. The light source includes a plurality of light emitting diodes, and at least one light emitting diode of the plurality of light emitting diodes is disposed such that an optical axis of the at least one light emitting diode extends in a direction different from a direction of an optical axis of another light emitting diode of the plurality of light emitting diodes.

In this manner, the optical axis of at least one of the light emitting diodes extends in a direction different from the direction of the optical axis of the rest of the light emitting diodes. Therefore, even when the light source has rotationally moved and become tilted, for example, the imaging target inside the vehicle cabin can be appropriately irradiated with light.

The light source may further include a substrate on which the plurality of light emitting diodes are mounted, and at least one light emitting diode of the plurality of light emitting diodes may be disposed on the substrate at an orientation different from an orientation of the other light emitting diode.

With this configuration, the optical axis of at least one of the light emitting diodes can be made to extend in a direction different from the direction of the optical axis of the rest of the light emitting diodes. Therefore, even when the light source has rotationally moved and become tiled, for example, the imaging target inside the vehicle cabin can be appropriately irradiated with light.

The substrate may include a curved surface, and the plurality of light emitting diodes may be disposed on the curved surface of the substrate.

With this configuration, the optical axis of at least one of the light emitting diodes can be easily made to extend in a direction different from the direction of the optical axis of the rest of the light emitting diodes. Therefore, even when the light source has rotationally moved and become tilted, for example, the imaging target inside the vehicle cabin can be appropriately irradiated with light.

The electronic mirror may include a casing including an opening and a liquid crystal panel provided in the opening, and the camera and the light source may be disposed inside the casing.

With this configuration, even when the light source has rotationally moved and become tilted along with the casing of the electronic mirror, for example, the imaging target inside the vehicle cabin can be appropriately irradiated with light by use of a light emitting diode whose optical axis extends in a direction different from the direction of the optical axis of the rest of the light emitting diodes.

The camera may be disposed inside the casing with the camera fixed to a support member provided in the vehicle cabin, the electronic mirror may be rotatable relative to the support member, and the light source may rotationally move along with rotation of the electronic mirror.

With this configuration, when the light source has rotationally moved and become tilted along with the electronic mirror, the imaging target inside the vehicle cabin can be appropriately irradiated with light by use of a light emitting diode whose optical axis extends in a direction different from the direction of the optical axis of the rest of the light emitting diodes.

The light source may include a plurality of light emitting diode groups each including one or more of the plurality of light emitting diodes, and the plurality of light emitting diode groups may each be supplied with power via a different power line.

This configuration makes it possible to control the emission of light by the light emitting diodes light emitting diode group by light emitting diode group. Therefore, the imaging target inside the vehicle cabin can be appropriately irradiated with light.

The in-cabin monitoring system may further include a controller that controls the camera, the electronic mirror, and the light source. The controller may recognize brightness of a plurality of regions of the imaging target based on an image captured by the camera and control emission of light by the plurality of light emitting diodes in accordance with the brightness of the plurality of regions.

With this configuration, the controller controls the emission of light by the plurality of light emitting diodes in accordance with the brightness of the plurality of regions, and this makes it possible to appropriately irradiate the imaging target inside the vehicle cabin with light.

The in-cabin monitoring system may further include a controller that controls the camera, the electronic mirror, and the light source. The controller may cause, of the plurality of light emitting diodes, a light emitting diode of which the optical axis is oriented toward the imaging target to emit light more intensely than a light emitting diode of which the optical axis is not oriented toward the imaging target.

With this configuration, the controller causes the light emitting diode whose optical axis is oriented toward the imaging target to emit light more intensely, and this makes it possible to irradiate the imaging target inside the vehicle cabin with sufficient light.

The in-cabin monitoring system may further include a controller that controls the camera, the electronic mirror, and the light source. The controller may cause, of the plurality of light emitting diodes, a light emitting diode of which the optical axis is not oriented toward the imaging target to emit light less intensely than a light emitting diode of which the optical axis is oriented toward the imaging target.

As the controller causes the light emitting diode whose optical axis is not oriented toward the imaging target to emit light less intensely, the quantity of light to be emitted from the light source can be reduced. This can reduce heat generated in the light source. Moreover, the power consumed by the light source can be reduced. Furthermore, shortening of the lifetime of the light emitting diodes can suppressed.

The in-cabin monitoring system may further include a controller that controls the camera, the electronic mirror, and the light source. The controller may cause, of the plurality of light emitting diodes, a light emitting diode closest to the imaging target to emit light more intensely than a light emitting diode farthest from the imaging target.

In this manner, the controller causes the light emitting diode that is the closest to the imaging target to emit light more intensely. Therefore, the imaging target inside the vehicle cabin can be irradiated with sufficient light.

The in-cabin monitoring system may further include a controller that controls the camera, the electronic mirror, and the light source. When one or more light emitting diodes of the plurality of light emitting diodes are disposed close to fields of view of a lens in the camera, the controller may lower emission intensity of the one or more light emitting diodes disposed close to the fields of view of the lens.

This configuration can keep any unwanted light from entering the fields of view of the lens. Thus, an image of the imaging target can be obtained with high accuracy.

The plurality of light emitting diodes may be disposed outside fields of view of a lens in the camera.

This configuration can keep any unwanted light from entering the fields of view of the lens. Thus, an image of the imaging target can be obtained with high accuracy.

The light source may include a first light source and a second light source. An optical axis of at least one light emitting diode of the plurality of light emitting diodes included in the first light source may extend in a direction of a driver's seat, and an optical axis of at least one light emitting diode of the plurality of light emitting diodes included in the second light source may extend in a direction of a passenger seat.

This configuration makes it possible to appropriately provide irradiation light in the direction of the driver's seat and in the direction of the passenger seat.

Hereinafter, some embodiments of the present disclosure will be described in detail by reference to the drawings. It is to be noted that the embodiments described hereinafter are merely examples, and the present disclosure is not limited by these embodiments. In other words, the embodiments described hereinafter illustrate some general or specific examples. The numerical values, the shapes, the materials, the constituent elements, the arrangement positions and the connection modes of the constituent elements, the steps, the order of the steps, and so on illustrated in the following embodiments are examples and are not intended to limit the present disclosure. Among the constituent elements according to the following embodiments, any constituent element that is not included in the independent claims expressing the broadest concept is to construed as an optional constituent element.

Moreover, the drawings are schematic diagrams and do not necessarily provide the exact depictions. Furthermore, constituent elements that are identical across the drawings are given identical reference characters.

### Embodiment

### Configuration of In-Cabin Monitoring System

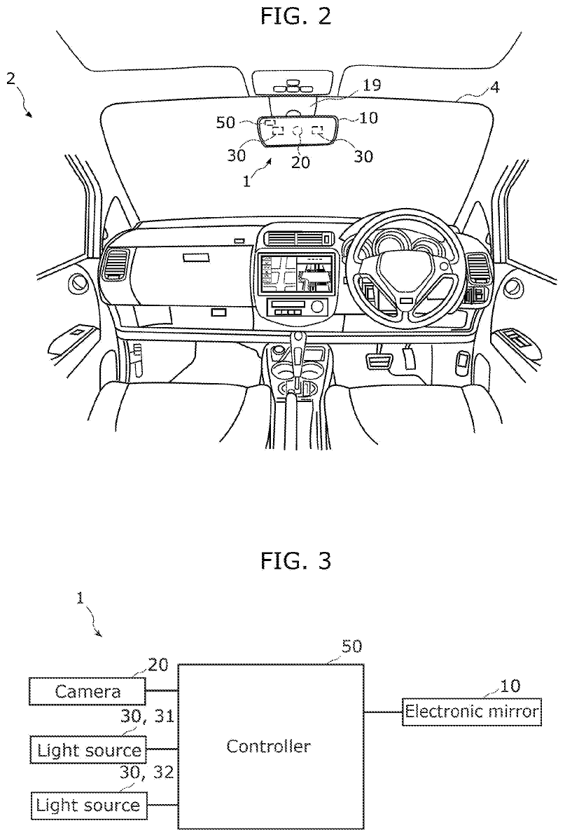

A configuration of an in-cabin monitoring system according to one embodiment will be described by reference to FIG. 2 to FIG. 8.

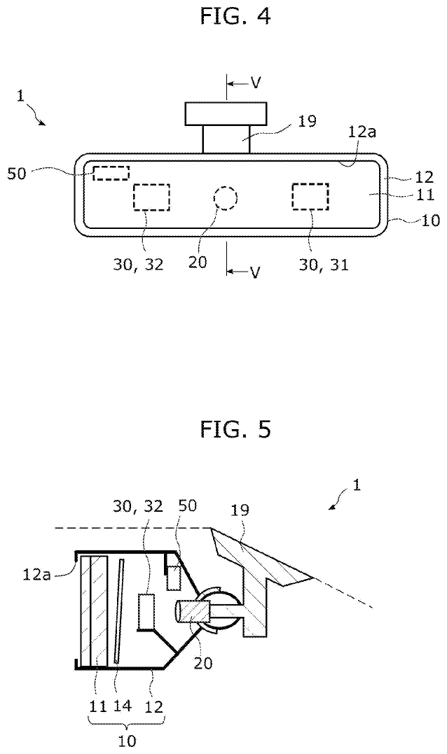

FIG. 2 is a schematic diagram of in-cabin monitoring system 1 according to one embodiment, as viewed in the forward direction from the rear end of vehicle cabin 2. FIG. 3 is a block configuration diagram illustrating in-cabin monitoring system 1. FIG. 4 is a diagram illustrating in-cabin monitoring system 1, as viewed toward the front side of electronic mirror 10. FIG. 5 is a sectional view of in-cabin monitoring system 1, as viewed along the V-V line indicated in FIG. 4.

As illustrated in FIG. 2 to FIG. 5, in-cabin monitoring system 1 includes electronic mirror 10, camera 20, light sources 30, and controller 50. Controller 50 controls electronic mirror 10, camera 20, and light sources 30.

Electronic mirror 10 is a rear view mirror in the vehicle and is provided inside vehicle cabin 2. For example, electronic mirror 10 is disposed on the ceiling-side part of windshield 4 of the vehicle so that electronic mirror 10 is visible to an occupant sitting in a seat. Electronic mirror 10 is connected to support member 19 provided in vehicle cabin 2. Support member 19 is a mounting bracket having a universal joint, and electronic mirror 10 is rotatable relative to support member 19. In this example, light sources 30, which will be described later, are provided inside electronic mirror 10 and configured to rotationally move along with the rotation of electronic mirror 10.

Electronic mirror 10 includes liquid crystal panel (LCP) 11, casing 12, and optical mirror 14 (see FIG. 5).

Casing 12 is a case made of resin and is made of a material that does not transmit infrared radiation. Casing 12 includes opening 12a. Camera 20, light sources 30, and controller 50 are disposed inside casing 12.

Liquid crystal panel 11 is made of a material that transmits infrared radiation. Liquid crystal panel 11 is provided in opening 12a such that the display surface of liquid crystal panel 11 is oriented in the rearward direction of the vehicle. Liquid crystal panel 11 may include a backlight or may be a self-emitting panel that includes no backlight. Liquid crystal panel 11 displays an image showing the space behind the vehicle that is captured by a separate camera (not illustrated). Moreover, liquid crystal panel 11 displays a face image or the like of an occupant based on a control command output from controller 50.

Optical mirror 14 is provided to show an image of the space behind the vehicle when liquid crystal panel 11 is not in use or cannot be put in use. Optical mirror 14 is a half-silvered mirror that reflects visible light and transmits infrared light and is provided between liquid crystal panel 11 and camera 20.

Camera 20 is a device that captures an image of imaging target 3. Imaging target 3 is an occupant inside vehicle cabin 2 or an object, such as a seat, inside vehicle cabin 2. Camera 20 is provided inside electronic mirror 10 so that camera 20 is not directly visible to an occupant. Camera 20 is a monocular camera and is disposed inside casing 12 with camera 20 fixed to support member 19 in vehicle cabin 2.

Camera 20 is, for example, an infrared (IR) camera. Infrared radiation (including near-infrared radiation) can pass through electronic mirror 10, and thus camera 20 can capture an image of imaging target 3 from the inside of electronic mirror 10. Camera 20 is disposed such that imaging target 3 becomes located inside the fields of view (FOV) of the lens in camera 20. Camera 20 is oriented in such a direction that camera 20 can capture an image of an occupant sitting in a seat, for example. An image of imaging target 3 captured by camera 20 is output to controller 50.

Light sources 30 are each a device that irradiates imaging target 3 inside vehicle cabin 2 with light. Light sources 30 each include a plurality of light emitting diodes (LEDs) that each emit infrared radiation, and thus light sources 30 emit light that is not visible to human eyes, such as infrared radiation. Infrared radiation can pass through liquid crystal panel 11 in electronic mirror 10, and thus light sources 30 can irradiate imaging target 3 with light from the inside of electronic mirror 10. Light sources 30 are provided inside electronic mirror 10 and oriented in such a direction that light sources 30 can irradiate an occupant sitting in a seat with infrared radiation.

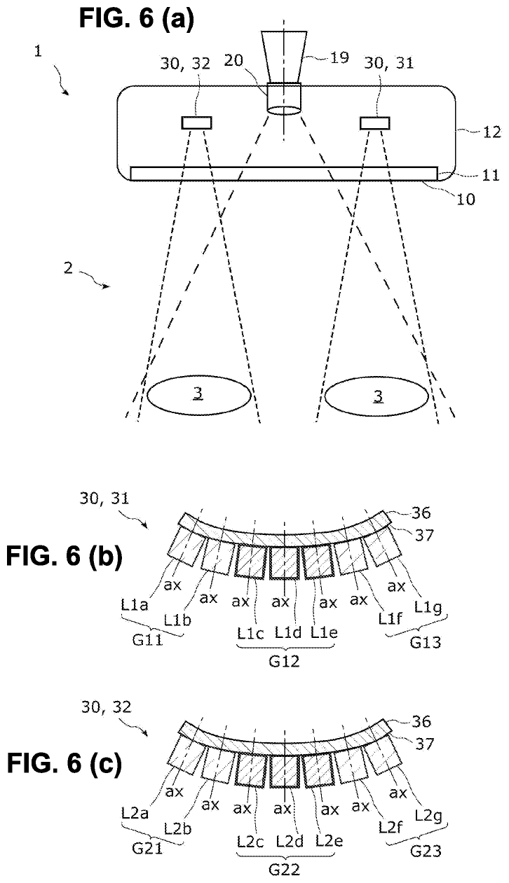

In FIG. 6, (a) is a diagram schematically illustrating in-cabin monitoring system 1, as viewed from the above; (b) is an enlarged sectional view of first light source 31, as viewed from the above; and (c) is an enlarged sectional view of second light source 32, as viewed from the above. Here, optical mirror 14 is omitted in FIG. 6.

As illustrated in (a) in FIG. 6, light sources 30 include first light source 31 and second light source 32. When viewed in the forward direction from the rear end of vehicle cabin 2, first light source 31 is disposed on the right side with the position of camera 20 serving as a reference, and second light source 32 is disposed on the left side with the position of camera 20 serving as a reference. For example, an optical axis of at least one light emitting diode included in first light source 31 extends in the direction of the driver's seat. Meanwhile, an optical axis of at least one light emitting diode included in second light source 32 extends in the direction of the passenger seat. Although light sources 30 are disposed so as to directly face the respective seats in FIG. 6, light sources 30 may be disposed so as to diagonally face the respective seats. Now, the light emitting diodes and so on will be described in detail.

As illustrated in (b) in FIG. 6, first light source 31 includes a plurality of light emitting diodes L1a, L1b, L1c, L1d, L1e, L1f, and L1g. The plurality of light emitting diodes L1a to L1g are disposed in this order in a direction along a horizontal plane. First light source 31 includes a plurality of light emitting diode groups G11, G12, and G13. In the example illustrated in (b) in FIG. 6, light emitting diode group G11 includes light emitting diodes L1a and L1b, light emitting diode group G12 includes light emitting diodes L1c, L1d, and L1e, and light emitting diode group G13 includes light emitting diodes L1f and L1g.

As illustrated in (c) in FIG. 6, second light source 32 includes a plurality of light emitting diodes L2a, L2b, L2c, L2d, L2e, L2f, and L2g. The plurality of light emitting diodes L2a to L2g are disposed in this order in a direction along a horizontal plane. Second light source 32 includes a plurality of light emitting diode groups G21, G22, and G23. In the example illustrated in (c) in FIG. 6, light emitting diode group G21 includes light emitting diodes L2a and L2b, light emitting diode group G22 includes light emitting diodes L2c, L2d, and L2e, and light emitting diode group G23 includes light emitting diodes L2f and L2g.

The plurality of light emitting diode groups G11 to G13 and the plurality of light emitting diode groups G21 to G23 are each supplied with power via a different power line. The plurality of light emitting diode groups G11 to G13 and the plurality of light emitting diode groups G21 to G23 each emit light at an emission intensity that differs light emitting diode group by light emitting diode group based on a control command of controller 50, which will be described later. Within each light emitting diode group, the light emitting diodes included therein can emit light at the same emission intensity. It is to be noted that each light emitting diode group does not need to include a plurality of light emitting diodes, and it suffices that a light emitting diode group include one or more light emitting diodes. Hereinafter, all of or one or more of the plurality of light emitting diodes may be collectively referred to as light emitting diode L or light emitting diodes L, and all of or one or more of the plurality of light emitting diode groups may be collectively referred to as light emitting diode group G or light emitting diode groups G.

First light source 31 and second light source 32 each include substrate 36, and a plurality of light emitting diodes L are mounted on each substrate 36. Each substrate 36 is a flexible substrate that can undergo flexure and includes curved surface 37. In this example, substrate 36 may be a hard substrate with its one principal surface being convex curved surface 37.

The plurality of light emitting diodes L are disposed on curved surface 37 of substrate 36. Therefore, at least one light emitting diode of the plurality of light emitting diodes L is disposed at a different orientation from the other light emitting diodes on substrate 36. In other words, at least one light emitting diode of the plurality of light emitting diodes L is disposed such that its optical axis ax extends in a direction different from the direction of optical axis ax of the rest of the light emitting diodes.

In the example illustrated in (b) in FIG. 6, light emitting diodes L are disposed such that optical axis ax of every light emitting diode L in first light source 31 extends in a direction different from the directions of optical axes ax of the rest of light emitting diodes L in first light source 31. Light emitting diodes L1a to L1g are disposed such that the angle of each optical axis ax changes gradually and such that optical axes ax of light emitting diodes L1a to L1g spread radially. The maximum difference in the angle of optical axis ax among light emitting diodes L1a to L1g is, for example, greater than or equal to 30° and smaller than or equal to 90°.

In the example illustrated in (c) in FIG. 6, light emitting diodes L are disposed such that optical axis ax of every light emitting diode L in second light source 32 extends in a direction different from the directions of optical axes ax of the rest of light emitting diodes L in second light source 32. Light emitting diodes L2a to L2g are disposed such that the angle of each optical axis ax changes gradually and such that optical axes ax of light emitting diodes L2a to L2g spread radially. The maximum difference in the angle of optical axis ax among light emitting diodes L2a to L2g is, for example, greater than or equal to 30° and smaller than or equal to 90°.

Controller 50 performs pulse duration modulation control on the plurality of light emitting diodes L (or the plurality of light emitting diode groups G) and thus adjusts the emission intensity of each of the plurality of light emitting diodes L (or each of the plurality of light emitting diode groups G).

Controller 50 includes a processor, such as a central processing unit (CPU), a storage including a volatile memory and a non-volatile memory, and a program stored in the storage. The functional configuration of controller 50 is implemented as the program is executed. Controller 50 is provided inside casing 12, but this is not a limiting example, and controller 50 may be provided outside casing 12. Controller 50 may control the operation of electronic mirror 10, camera 20, light sources 30, and so on while communicating with an electronic control unit (ECU) of the vehicle.

Now, how in-cabin monitoring system 1 operates in a configuration in which electronic mirror 10 is disposed in a tilted orientation will be described.

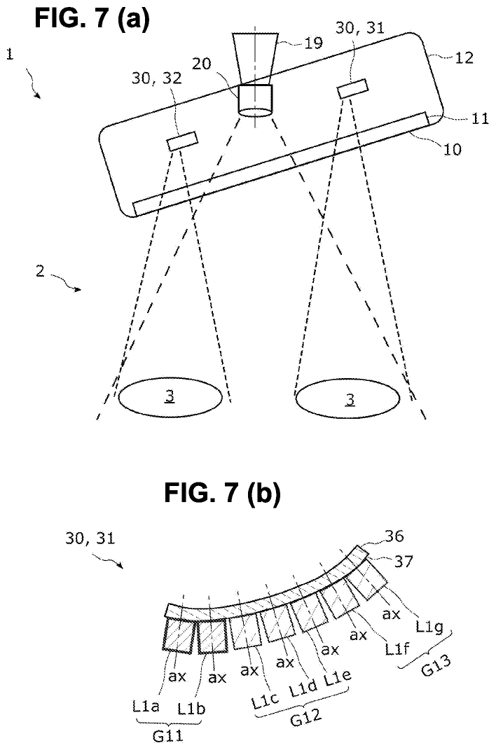

In FIG. 7, (a) is a diagram illustrating a state in which electronic mirror 10 of in-cabin monitoring system 1 is disposed in a tilted orientation, and (b) is an enlarged sectional view of first light source 31, as viewed from the above.

As illustrated in (a) in FIG. 7, electronic mirror 10 is rotatable relative to support member 19, and light sources 30 each rotationally move along with the rotation of electronic mirror 10. According to the present embodiment, controller 50 controls emission of light by the plurality of light emitting diodes L so that imaging target 3 can be irradiated appropriately with light when light sources 30 each rotationally move in the horizontal direction about a perpendicular axis.

Controller 50 recognizes the brightness of a plurality of regions of imaging target 3 based on an image captured by camera 20 and controls the emission of light by the plurality of light emitting diodes L in accordance with the brightness of the plurality of regions.

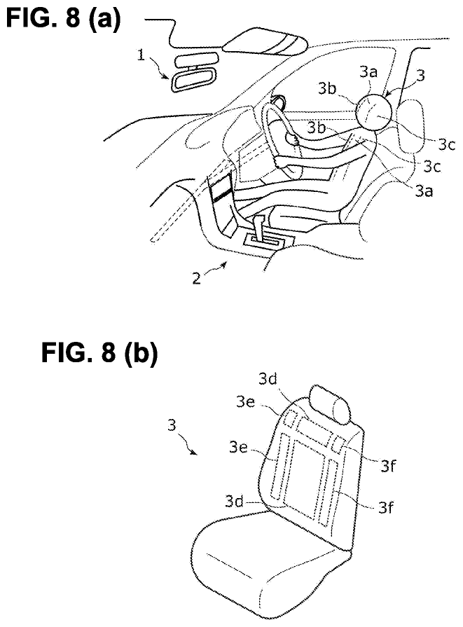

FIG. 8 is a diagram illustrating some examples of a plurality of regions of imaging target 3 whose image is to be captured by in-cabin monitoring system 1.

When imaging target 3 is an occupant as illustrated in (a) in FIG. 8, the plurality of regions include center region 3a, right side region 3b, and left side region 3c of the body of the occupant. The brightness of the plurality of regions is the illuminance of respective regions 3a to 3c. When imaging target 3 is a seat as illustrated in (b) in FIG. 8, the plurality of regions include center region 3d, right side region 3e, and left side region 3f of the seat. The brightness of the plurality of regions is the illuminance of respective regions 3d to 3f. In this manner, controller 50 controls the emission of light by the plurality of light emitting diodes L in accordance with the brightness of the plurality of regions, and this makes it possible to appropriately irradiate imaging target 3 with light.

In order for controller 50 to appropriately irradiate imaging target 3 with light, controller 50 may cause, of the plurality of light emitting diodes L, a light emitting diode whose optical axis ax is oriented toward imaging target 3 to emit light more intensely than a light emitting diode whose optical axis ax is not oriented toward imaging target 3. For example, as illustrated in (b) in FIG. 7, controller 50 may cause light emitting diodes L1a and L1b of light emitting diode group G11 whose optical axes ax are oriented toward imaging target 3 to emit light more intensely than light emitting diodes L1c to L1g of light emitting diode groups G12 and G13 whose optical axes ax are not oriented toward imaging target 3. Meanwhile, when electronic mirror 10 is disposed not in a tilted orientation (see FIG. 6), controller 50 may cause light emitting diodes L1c to L1e of light emitting diode group G12 whose optical axes ax are oriented toward imaging target 3 to emit light more intensely than light emitting diodes L1a, L1b, L1f, and L1g of light emitting diode groups G11 and G13 whose optical axes ax are not oriented toward imaging target 3.

Alternatively, in order to reduce the total quantity of light to be emitted from the plurality of light emitting diodes L, controller 50 may cause, of the plurality of light emitting diodes L, a light emitting diode whose optical axis ax is not oriented toward imaging target 3 to emit light less intensely than a light emitting diode whose optical axis ax is oriented toward imaging target 3. For example, as illustrated in FIG. 7, controller 50 may cause light emitting diodes L1c to L1g of light emitting diode groups G12 and G13 whose optical axes ax are not oriented toward imaging target 3 to emit light less intensely than light emitting diodes L1a and L1b of light emitting diode group G11 whose optical axes ax are oriented toward imaging target 3. Meanwhile, when electronic mirror 10 is disposed not in a tilted orientation (see FIG. 6), controller 50 may cause light emitting diodes L1a, L1b, L1f, and L1g of light emitting diode groups G11 and G13 whose optical axes ax are not oriented toward imaging target 3 to emit light less intensely than light emitting diodes L1c to L1e of light emitting diode group G12 whose optical axes ax are oriented toward imaging target 3.

Alternatively, controller 50 may cause, of the plurality of light emitting diodes L, a light emitting diode that is the closest to imaging target 3 to emit light more intensely than a light emitting diode that is the farthest from imaging target 3. For example, as illustrated in FIG. 7, controller 50 may cause light emitting diode L1a that is the closest to imaging target 3 to emit light more intensely than light emitting diode L1g that is the farthest from imaging target 3. Meanwhile, when electronic mirror 10 is disposed not in a tilted orientation (see FIG. 6), controller 50 may cause light emitting diode L1d that is the closest to imaging target 3 to emit light more intensely than light emitting diodes L1a and L1g that are both the farthest from imaging target 3.

In in-cabin monitoring system 1 according to the present embodiment, light sources 30 each include a plurality of light emitting diodes L, and at least one light emitting diode of the plurality of light emitting diodes L is disposed such that its optical axis ax extends in a direction different from the direction of optical axis ax of the rest of the light emitting diodes.

With this configuration, optical axis ax of at least one light emitting diode extends in a direction different from the directions of optical axes ax of the rest of the light emitting diodes. Therefore, even when light sources 30 have each rotationally moved and become tilted, for example, imaging target 3 inside vehicle cabin 2 can be appropriately irradiated with light.

### Variation 1 of Embodiment

In-cabin monitoring system 1A according to Variation 1 of the embodiment will be described. In the example described according to Variation 1, a plurality of light emitting diodes L are embedded in liquid crystal panel 11.

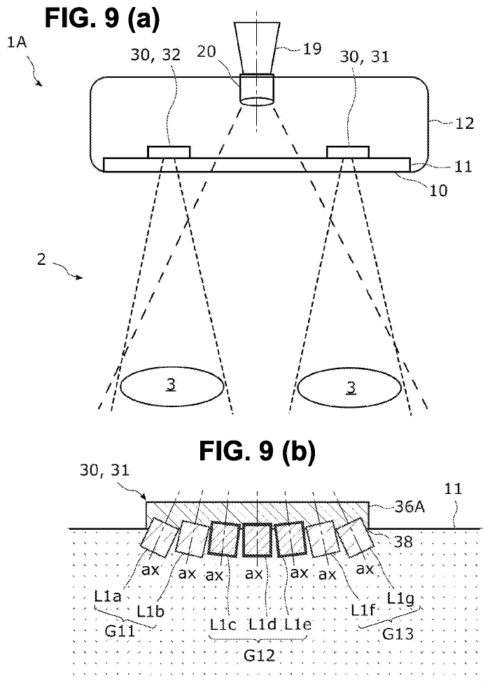

In FIG. 9, (a) is a diagram schematically illustrating light sources 30 of in-cabin monitoring system 1A according to Variation 1, as viewed from the above; and (b) is an enlarged sectional view of first light source 31, as viewed from the above.

As illustrated in (a) in FIG. 9, light sources 30 include first light source 31 and second light source 32. Light emitting diodes L1a to L1g of first light source 31 are disposed in this order in a direction along a horizontal plane (see (b) in FIG. 9) and are embedded in the backlight of liquid crystal panel 11. Light emitting diodes L2a to L2g of second light source 32 are disposed in this order in a direction along a horizontal plane and are embedded in the backlight of liquid crystal panel 11.

As illustrated in (b) in FIG. 9, first light source 31 includes substrate 36A, and a plurality of light emitting diodes L are mounted on substrate 36A. Substrate 36A is a hard substrate with its one principal surface being uneven surface 38.

The plurality of light emitting diodes L are disposed on uneven surface 38 of substrate 36A. Therefore, at least one light emitting diode of the plurality of light emitting diodes L is disposed at a different orientation from the other light emitting diodes on substrate 36A. In other words, at least one light emitting diode of the plurality of light emitting diodes L is disposed such that its optical axis ax extends in a direction different from the direction of optical axis ax of the rest of the light emitting diodes. This description applies also to second light source 32.

In in-cabin monitoring system 1A according to Variation 1, light sources 30 each include a plurality of light emitting diodes L, and at least one light emitting diode of the plurality of light emitting diodes L is disposed such that its optical axis ax extends in a direction different from the direction of optical axis ax of the rest of the light emitting diodes.

In this manner, at least one of the light emitting diodes is disposed such that its optical axis ax extends in a different direction. Therefore, even when light sources 30 have rotationally moved and become tilted, for example, imaging target 3 inside vehicle cabin 2 can be appropriately irradiated with light.

### Variation 2 of Embodiment

In-cabin monitoring system 1B according to Variation 2 of the embodiment will be described. In the example described according to Variation 2, a plurality of light emitting diodes L are disposed outside fields of view a of the lens in camera 20.

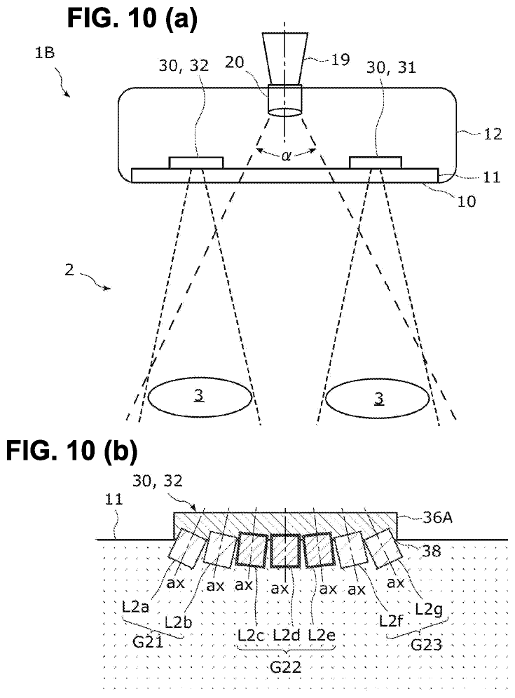

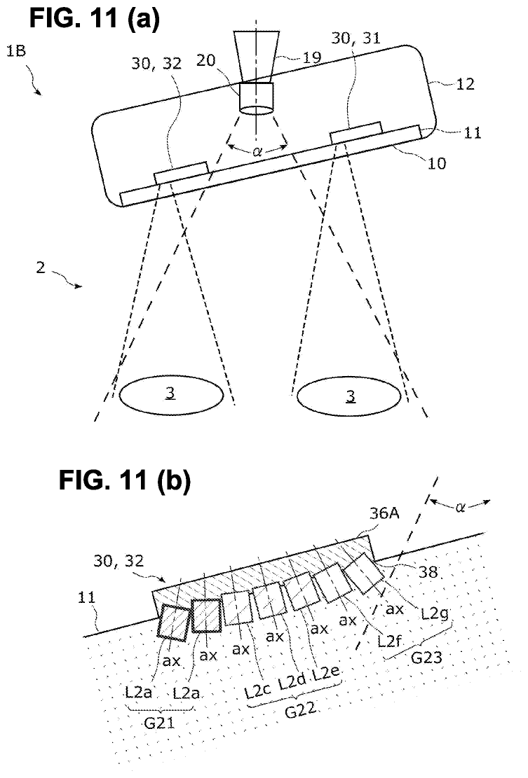

In FIG. 10, (a) is a diagram schematically illustrating in-cabin monitoring system 1B according to Variation 2, as viewed from the above; and (b) is an enlarged sectional view of second light source 32, as viewed from the above. In FIG. 11, (a) is a diagram illustrating a state in which electronic mirror 10 of in-cabin monitoring system 1B is disposed in a tilted orientation, and (b) is an enlarged sectional view of second light source 32, as viewed from the above.

As illustrated in (a) and (b) in FIG. 10, when electronic mirror 10 is oriented directly toward the rear end of vehicle cabin 2 in in-cabin monitoring system 1B according to Variation 2, the plurality of light emitting diodes L are disposed outside fields of view a of the lens in camera 20. In addition, as illustrated in (a) and (b) in FIG. 11, when electronic mirror 10 is disposed in a tilted orientation as well, the plurality of light emitting diodes L are disposed outside fields of view a of the lens in camera 20. In this manner, disposing light emitting diodes L outside fields of view a of the lens makes it possible to keep any unwanted light from entering fields of view a of the lens.

Furthermore, according to Variation 2, in order to further keep unwanted light from entering fields of view a of the lens, controller 50 performs the following emission control. When, of the plurality of light emitting diodes L, one or more light emitting diodes are disposed close to fields of view a of the lens in camera 20, controller 50 lowers the emission intensity of the one or more light emitting diodes disposed close to fields of view a of the lens. That a light emitting diode is disposed close to fields of view a of the lens means that the distance between this light emitting diode and the edge of fields of view a of the lens is greater than 0 mm and less than or equal to 5 mm.

For example, when light emitting diodes L2f and L2g of light emitting diode group G23 are disposed close to fields of view a of the lens as illustrated in (b) in FIG. 11, controller 50 may lower the emission intensity of light emitting diodes L2f and L2g to reduce the quantity of light emitted from light emitting diodes L2f and L2g. Light emitting diodes L2f and L2g, whose quantity of light to be emitted has been reduced, have a lower emission intensity than other light emitting diodes L2a to L2e. In this example, when controller 50 lowers the emission intensity of light emitting diodes L2f and L2g, controller 50 may lower the emission intensity of light emitting diodes L2f and L2g to zero (lower the quantity of light to be emitted to zero).

According to Variation 2 as well, at least one of the light emitting diodes is disposed such that its optical axis ax extends in a different direction. Therefore, even when light sources 30 have rotationally moved and become tilted, for example, imaging target 3 inside vehicle cabin 2 can be appropriately irradiated with light.

### Variation 3 of Embodiment

In-cabin monitoring system 1C according to Variation 3 of the embodiment will be described. In the example described according to Variation 3, liquid crystal panel 11 in electronic mirror 10 is transparent display 11C.

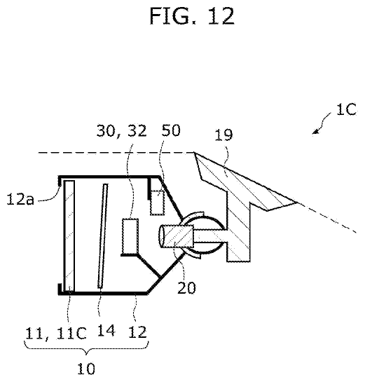

FIG. 12 is a sectional view of electronic mirror 10 of in-cabin monitoring system 1C according to Variation 3, as viewed from the side.

Electronic mirror 10 according to Variation 3 includes transparent display 11C, casing 12, and optical mirror 14. Transparent display 11C is a display that allows the background to be visible through lattice-patterned see-through portions.

Casing 12 is a case made of resin and includes opening 12a. Camera 20, light sources 30, and controller 50 are disposed inside casing 12.

Transparent display 11C is provided in opening 12a such that the display surface of transparent display 11C is oriented in the rearward direction of the vehicle. Transparent display 11C displays an image showing the space behind the vehicle that is captured by a separate camera (not illustrated). Moreover, transparent display 11C displays a face image or the like of an occupant based on a control command output from controller 50.

Optical mirror 14 is provided to show an image of the space behind the vehicle when transparent display 11C is not in use or cannot be put in use. Optical mirror 14 is a half-silvered mirror that reflects visible light and transmits infrared light and is provided between transparent display 11C and camera 20.

In this example, when optical mirror 14 does not need to be provided, camera 20 may be an RGB/IR camera that can detect both visible light and infrared radiation.

According to Variation 3 as well, at least one of the light emitting diodes is disposed such that its optical axis ax extends in a different direction. Therefore, even when light sources 30 have rotationally moved and become tilted, for example, imaging target 3 inside vehicle cabin 2 can be appropriately irradiated with light.

### Other Embodiments

As described thus far, the embodiment and the variations of the embodiment have been described to illustrate the technique disclosed in the present application. However, techniques according to the embodiment and the variations of the embodiment are not limited to the above and can also be applied to other embodiments that include modifications, substitutions, additions, omissions, and so on, as appropriate. Moreover, a new embodiment can also be conceived of by combining the constituent elements described in the foregoing embodiments.

In the example described according to the foregoing embodiment, light sources 30 are provided inside electronic mirror 10, but this is not a limiting example. For example, light sources 30 may be provided outside electronic mirror 10 as long as light sources 30 are in contact with casing 12 of electronic mirror 10.

In the example described according to the foregoing embodiment, the plurality of light emitting diodes L are disposed in a direction along a horizontal plane, but this is not a limiting example. For example, the plurality of light emitting diodes L may be disposed in a direction along a vertical plane when electronic mirror 10 is rotatable in the vertical direction about the horizontal axis.

In the example described according to the foregoing embodiment, the emission of light by the plurality of light emitting diodes L is controlled in accordance with the brightness of the plurality of regions of imaging target 3, but this is not a limiting example. For example, controller 50 may detect the angle of rotation of electronic mirror 10 by use of an angle sensor or the like provided in support member 19 and control the emission of light by the plurality of light emitting diodes L based on the detected angle of rotation.

The embodiments according to the present disclosure have been described in detail by reference to the drawings. The function of each of the devices and the processors described above can be implemented by a computer program.

A computer that implements the above-described functions through a program includes, for example, an input device, such as a touch pad; an output device, such as a display or a speaker; a processor or a central processing unit (CPU); a read only memory (ROM); a random access memory (RAM); a storage device, such as a hard disk device or a solid state drive (SSD); a reading device that reads out information from a recording medium such as a digital versatile disk read only memory (DVD-ROM) or a universal serial bus (USB) memory; and a network card that carries out communication via a network. Each of these components is connected via a bus.

The reading device reads out the program from a recording medium having the program recorded therein and stores the read-out program into the storage device. Alternatively, the network card communicates with a server device connected to a network and stores, into the storage device, a program that has been downloaded from the server device and that is for implementing the function of each of the devices described above.

Then, the processor or the CPU copies the program stored in the storage device into the RAM and successively reads out instructions included in the program from the RAM and executes them accordingly. Thus, the function of each of the devices described above is implemented.

While various embodiments have been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims are incorporated herein by reference in their entirety: Japanese Patent Application No. 2021-056317 filed on Mar. 29, 2021.

### INDUSTRIAL APPLICABILITY

An in-cabin monitoring system according to the present disclosure can find its use in capturing an image of, for example, an occupant inside a vehicle cabin.

1. An in-cabin monitoring system comprising:
an electronic mirror provided inside a vehicle cabin;
a camera that captures an image of an imaging target inside the vehicle cabin; and
a light source that is provided in the electronic mirror and emits light into the vehicle cabin, wherein
the light source includes a plurality of light emitting diodes, and
at least one light emitting diode of the plurality of light emitting diodes is disposed such that an optical axis of the at least one light emitting diode extends in a direction different from a direction of an optical axis of an other light emitting diode of the plurality of light emitting diodes.

2. The in-cabin monitoring system according to claim 1, wherein
the light source further includes a substrate on which the plurality of light emitting diodes are mounted, and
the at least one light emitting diode of the plurality of light emitting diodes is disposed on the substrate at an orientation different from an orientation of the other light emitting diode.

3. The in-cabin monitoring system according to claim 2, wherein
the substrate includes a curved surface, and
the plurality of light emitting diodes are disposed on the curved surface of the substrate.

4. The in-cabin monitoring system according to claim 1, wherein
the electronic mirror includes:
a casing including an opening; and
a liquid crystal panel provided in the opening, and
the camera and the light source are disposed inside the casing.

5. The in-cabin monitoring system according to claim 4, wherein
the camera is disposed inside the casing with the camera fixed to a support member provided in the vehicle cabin,
the electronic mirror is rotatable relative to the support member, and
the light source rotationally moves along with rotation of the electronic mirror.

6. The in-cabin monitoring system according to claim 1, wherein
the light source includes a plurality of light emitting diode groups each including one or more of the plurality of light emitting diodes, and
the plurality of light emitting diode groups are each supplied with power via a different power line.

7. The in-cabin monitoring system according to claim 1, further comprising:
a controller that controls the camera, the electronic mirror, and the light source, wherein
the controller recognizes brightness of a plurality of regions of the imaging target based on an image captured by the camera and controls emission of light by the plurality of light emitting diodes in accordance with the brightness of the plurality of regions.

8. The in-cabin monitoring system according to claim 1, further comprising:
a controller that controls the camera, the electronic mirror, and the light source, wherein
the controller causes, of the plurality of light emitting diodes, a light emitting diode of which the optical axis is oriented toward the imaging target to emit light more intensely than a light emitting diode of which the optical axis is not oriented toward the imaging target.

9. The in-cabin monitoring system according to claim 1, further comprising:
a controller that controls the camera, the electronic mirror, and the light source, wherein
the controller causes, of the plurality of light emitting diodes, a light emitting diode of which the optical axis is not oriented toward the imaging target to emit light less intensely than a light emitting diode of which the optical axis is oriented toward the imaging target.

10. The in-cabin monitoring system according to claim 1, further comprising:
a controller that controls the camera, the electronic mirror, and the light source, wherein
the controller causes, of the plurality of light emitting diodes, a light emitting diode closest to the imaging target to emit light more intensely than a light emitting diode farthest from the imaging target.

11. The in-cabin monitoring system according to claim 1, further comprising:
a controller that controls the camera, the electronic mirror, and the light source, wherein
when one or more light emitting diodes of the plurality of light emitting diodes are disposed close to fields of view of a lens in the camera, the controller lowers emission intensity of the one or more light emitting diodes disposed close to the fields of view of the lens.

12. The in-cabin monitoring system according to claim 1, wherein
the plurality of light emitting diodes are disposed outside fields of view of a lens in the camera.

13. The in-cabin monitoring system according to claim 1, wherein
the light source includes a first light source and a second light source,
optical axes of at least one light emitting diode of the plurality of light emitting diodes included in the first light source extend in a direction of a driver's seat, and
optical axes of at least one light emitting diode of the plurality of light emitting diodes included in the second light source extend in a direction of a passenger seat.
